(19) United States
(12) Patent Application Publication
(10) Pub. No.: US 2024/0065129 A1
(43) Pub. Date: Feb. 29, 2024

(54) AGRICULTURAL WORK SYSTEM AND METHOD OF OPERATING AN AGRICULTURAL WORK SYSTEM

(71) Applicant: CLAAS Tractor SAS, VéIizy-Villacoublay Cedex (FR)

(72) Inventors: Christian Birkmann, Versmold (DE); Christian Schaub, Paderborn (DE)

(73) Assignee: CLAAS Tractor SAS, VéIizy-Villacoublay Cedex (FR)

(21) Appl. No.: 18/237,739

(22) Filed: Aug. 24, 2023

(30) Foreign Application Priority Data
Aug. 25, 2022 (DE) 10 2022 121 569.5

(51) Int. Cl. A01B 63/00; A01B 79/00

(52) U.S. Cl. CPC A01B 63/008; A01B 79/005

(57) ABSTRACT

An agricultural work system and a method for operating an agricultural work system is disclosed. The agricultural work system comprises an agricultural production machine having two axles, a power lifter, and a driver assistance system, and an attachment connected to the agricultural production machine using the power lifter. The driver assistance system optimizes operation of the agricultural production machine by determining an axle load on at least one of the axles. Further, actual data records coupled in time to the execution of an agricultural work process are cyclically determined by the driver assistance system to automatically adjust the power lifter. In particular, an axle load ratio currently at the axles is determined as an actual data record and, using at least one additional actual data record to be determined, the driver assistance system automatically generates instructions to actuate the power lifter while simultaneously accounting for mutually influencing optimization target variables.

### CROSS REFERENCE TO RELATED APPLICATION

This application claims priority under 35 U.S.C. § 119 to German Patent Application No. DE 10 2022 121 569.5 filed Aug. 25, 2022, the entire disclosure of which is hereby incorporated by reference herein. This application is related to U.S. application Ser. No. ______ (attorney docket number 15191-23019A (P05618/8)), incorporated by reference herein in its entirety.

### TECHNICAL FIELD

The present invention relates to an agricultural work system and a method for operating an agricultural work system.

### BACKGROUND

This section is intended to introduce various aspects of the art, which may be associated with exemplary embodiments of the present disclosure. This discussion is believed to assist in providing a framework to facilitate a better understanding of particular aspects of the present disclosure. Accordingly, it should be understood that this section should be read in this light, and not necessarily as admissions of prior art.

An agricultural work system may comprise an agricultural production machine and an attachment. The agricultural production machine may have at least two axles and at least one power lifter, with the attachment being connected to the agricultural production machine using in order for the agricultural work system to perform an agricultural work process. The power lifter may be configured for operation, in which the configuration of the power lifter may be performed manually by an operator of the agricultural work system or by a driver assistance system optimizing the operation of the agricultural production machine. For example, EP 2 269 432 B1 describes a control unit for a hydraulic assembly of a hydraulically operated device interface on a tractor.

As another example, US Patent Application Publication No. 2022/0000006 A1, incorporated by reference herein in its entirety, discloses an agricultural production machine (designed as a tractor) with a driver assistance system that optimizes the operation of the agricultural production machine. The driver assistance system comprises an automatic lifting mechanism for adjusting a power lifter, which may be configured to operate on the basis of characteristic curves. The automatic lifting mechanism may be configured for optimized adjustment of at least one working parameter of the tractor as a function of selectable control strategies and/or optimization target variables stored in a memory unit. The selectable control strategy may comprise any one, any combination, or all of “efficiency” strategy, “performance” strategy, “cost” strategy, “quality” strategy, “yield” strategy. The selectable optimization target variables may include a target variable of “area output”, “area consumption”, “yield per area”, “cost per area”, and/or “quality of work”. The power lifter may be controlled by the driver assistance system based on a higher-level objective for the agricultural work system.

### BRIEF DESCRIPTION OF THE DRAWINGS

The present application is further described in the detailed description which follows, in reference to the noted drawings by way of non-limiting examples of exemplary implementation, in which like reference numerals represent similar parts throughout the several views of the drawings, and wherein:

FIG. 1 schematically illustrates a side view of an agricultural production machine of an agricultural work system;

FIG. 2 schematically illustrates the agricultural work system consisting of the agricultural production machine and mounted attachment; and

FIG. 3 illustrates a schematic overview of the structure of a driver assistance system.

### DETAILED DESCRIPTION

As discussed in the background, EP 2 269 432 B1 describes a control unit for a hydraulic assembly of a hydraulically operated device interface on a tractor. As discussed in more detail below, in order to improve the control of contact pressure for an attachment connected to the device interface, it is disclosed the a device associated with the axle assembly (either integrated with the axle assembly such as provided on an axle assembly or working in combination with the axle assembly) is configured to detect a load status of the axle of the agricultural vehicle, with a device, such as the driver assistance system, generating one or more control signals for actuating the hydraulic assembly, with the one or more control signals being generated based on (such as a function of) the detected load status on the axle.

Further, as discussed in the background, US Patent Application Publication No. 2022/0000006 A1 discloses that the automatic lifting mechanism may be configured for optimized automatic adjustment of at least one working parameter of the tractor as a function of selectable control strategies and/or optimization target variables stored in a memory unit. Further, the power lifter may be controlled by the driver assistance system based on a higher-level objective for the agricultural work system. However, more specific target variables, such as traction or the maintenance of axle load ratios permissible for operation may lead to conflicting targets, which may be subordinated in the adjustment of the power lifter at the expense of the control strategy or optimization target variable so that the overall efficiency in the execution of the agricultural work process is below a possible optimum.

Thus, in one or some embodiments, a method and a system are disclosed to enable more efficient operation of the agricultural work system taking into account dynamically changing conditions during the execution of an agricultural work process.

In one or some embodiments, a method for operating an agricultural work system is disclosed. The agricultural work system includes an agricultural production machine having at least two axles with at least one power lifter, such as a rear power lifter, and an attachment which is connected or may be connected to the agricultural production machine via the power lifter in order for the agricultural work system to perform an agricultural work process. The agricultural work system (such as resident on the agricultural production machine) may include a driver assistance system, which may be configured to control (such as optimize) the operation of the agricultural production machine. The drive assistance system may include a computing unit, a memory unit and an operating and display unit (e.g., a touchscreen), wherein information generated by the at least one sensor assembly, external information and information stored in the memory unit may be automatically accessed and/or processed by the computing unit. For example, the driver assistance system may determine an axle load on at least one of the axles using data generated by the at least one sensor assembly. In one or some embodiments, the driver assistance system may determine (such as cyclically determine) actual data records coupled in time to the execution of the agricultural work process in order for the driver assistance system to automatically generate one or more commands to adjust the power lifter. In particular, the driver assistance system may automatically determine, such as dynamically automatically determine (e.g., dynamically determine the changing of) an axle load ratio currently on the axles as actual data record. Further, the driver assistance system may automatically determine at least one additional actual data record (e.g., a dynamically changing actual data record), and responsive to the automatic determination, may automatically generate one or more commands (e.g., instructions) in order to automatically actuate the power lifter so that the driver assistance system may simultaneously taking into account or consider a plurality of mutually influencing optimization target variables (which may be stored as one or more target records).

In one or some embodiments, a fundamental consideration may comprise a dynamic multi-objective control, which may be the basis of the optimization process to be performed, which may increase the overall efficiency of the agricultural work system in performing the agricultural work process. In particular, the multi-objective control of the driver assistance system may take into account the objectives of the mutually influencing optimization target variables when generating the instructions for actuating the power lifter.

In one or some embodiments, mutually influencing optimization target variables may exist, inter alia, between a soil tillage depth and the achievement and maintenance of a slip for good traction properties of the agricultural production machine. For example, if the attachment is raised too far or too much, there may be a risk of overloading the tires on the rear axle of the agricultural production machine. In this regard, in one or some embodiments, the driver assistance system may consider the different objectives in generating the instructions for actuating the power lifter.

In addition, in one or some embodiments, the driver's workload may be reduced because the driver may not need to make manual adjustments for optimum work performance when performing the agricultural work process.

For this purpose, any one, any combination, or all of the following may be performed to determine the additional (e.g., dynamically changing) actual data records: a cyclically determined slip determination time-linked to the execution of the working process; a determination of the working depth of tools of an attachment designed as a soil cultivation device; or a determination of the inner tire pressure of soil engagement means (e.g., tires, tracks, or the like). For example, the driver assistance system may perform the determination of the slip, working depth and/or inner tire pressure. Determining the axle load ratio as an actual data record, which may change dynamically, makes it possible to shift the axle loads between the axles into an optimum range. By determining the slip as an actual data record, which may change dynamically, it may be possible to ensure that the agricultural production machine is driven in the traction-capable range. The determination of the working depth as an actual data record, such as a dynamically changing actual data record, may be used to reduce the rolling resistance on the attachment. Another aspect of determining the working depth as an actual data record may be to use this actual data record to increase the tractive force potential of the agricultural production machine, taking into account the limited load-bearing capacity of tires and/or the axles of the agricultural production machine. The determination of the inner tire pressure as an actual data record, which may change dynamically, may be used to maintain the permissible axle loads for a set inner tire pressure. Thus, it may be taken into account that maximum permissible axle loads for the currently set inner tire pressure are not exceeded.

In one or some embodiments, target data records may be specified for determining deviations in the actual data records used for multi-objective control, and they may be determined in any one, any combination, or all of: retrieved from a database; determined using an expert system stored in the memory unit; or entered by an operator using a man-machine interface (e.g., based on a natural-language interactive dialog using a touchscreen or the like). In one or some embodiments, the database is stored in the memory unit of the driver assistance system. Alternatively or additionally, the database may be stored on a remote data processing system with which the driver assistance system may exchange data by suitable means of communication (e.g., using a communication interface on the agricultural production machine, the driver assistance system may communicate wirelessly with the remote data processing system, such as via the internet). In one or some embodiments, the remote data processing system may be cloud-based. In one or some embodiments, the man-machine interface may be the operating and display unit of the driver assistance system or a mobile data processing device, such as a smartphone or tablet computer.

In one or some embodiments, the expert system may provide target data records based on stored expert knowledge. The expert system may also be designed as a functional system model for at least part of the agricultural work system, which may be stored in the memory unit of the driver assistance system. In one or some embodiments, for mapping the functional relationships by means of the system model, it may be provided that at least one characteristic curve field is assigned to a target data record, wherein the target data record is the output variable of the particular characteristic curve field. In this context, the characteristic curve field may very generally represent the dependence of an output variable on at least one input variable, such as on two or more input variables. For example, an output variable for the target data record of the axle load ratio may have the target data records (alternatively termed target records) for any one, any combination, or all of the following input variables assigned to it: a maximum permissible slip; a target working depth; or a target internal (or inner) tire pressure. Because of the multiple target control, this may apply accordingly to the other target data records as output variables.

In one or some embodiments, any one, any combination, or all of the following may be determined by the driver assistance system as optimization target variables: a target axle load ratio; a target load of weight-supporting devices on the attachment; a target working depth; a target slip limit; and a maximum axle load dependent on the target inner tire pressure.

In one or some embodiments, weight-supporting devices on the attachment may be support wheels, and rollers.

In one or some embodiments, the axle loads arising on the axles of the agricultural production machine and the axle load ratio based thereon may be determined cyclically by the computing unit of the driver assistance system, time-linked to the execution of the agricultural work process, taking into account a production machine and attachment configuration as well as operating parameters. The cyclical determination of the axle loads occurring on the axles of the agricultural production machine and the axle load ratio based thereon, which may be performed at specific, such as constant, time intervals, may take into account the agricultural production machine and attachment configuration and current operating parameters, thereby making it possible to provide the operator with almost real-time information about the dynamically changing axle loads and the axle load ratio during the execution of the agricultural work process.

It may be advantageous when a distinction is made between attachments mounted on the device interface and trailed attachments to determine the axle loads and the axle load ratio. Therefore, with a trailed attachment for soil cultivation, in a first step, tool forces exerted on tools of the attachment may be determined via tractive power and current travel speed of the agricultural production machine, and a vertical force supported on at least one weight-supporting device may be determined from a moment equilibrium about one of the axles, such as the rear axle, of the agricultural production machine, and in a second step, a vertical axle load acting on this axle (e.g., the rear axle) may be determined.

With a trailed attachment for soil cultivation, in a first step, tool forces exerted on tools of the attachment may be determined via tractive power and current travel speed, a coupling moment (or torque) acting by the attachment on the agricultural production machine as well as a vertical coupling force by means of attachment geometry, and the determination of a moment equilibrium around the attachment device support wheel, and in a second step, a vertical axle load acting on one of the axles, such as the rear axle, may be determined.

Furthermore, in a third step, the axle load ratio may be determined and, in a fourth step, an estimation of a drive torque at the axles of the agricultural production machine may be performed. In one or some embodiments, the execution of the third and fourth steps may be independent of whether the attachment is attached or mounted.

In particular, to determine the working depth of tools of the attachment, the position of the power lifter may be determined by measurement and/or calculation.

Alternatively or additionally, the determination of working depth of tools of the attachment may be performed based on sensor data of at least one working depth sensor resident on the attachment.

In one or some embodiments, a vehicle speed and/or a tire circumferential speed may be determined for slip determination. In one or some embodiments, the vehicle speed may be determined using radar sensor data and/or position location data, GPS data or GNSS data. The tire circumferential speed may be determined by using a speed sensor arranged or positioned on the axle and data of the tires (e.g., which may be stored in the agricultural production machine configuration on the at least one driven axle of the agricultural production machine).

In particular, the driver assistance system for actuating the power lifter may determine an optimum position of the power lifter, such as the optimum position of the upper link and lower link of a power lifter designed as a three-point power lifter, while simultaneously taking into account the mutually influencing optimization target variables.

In one or some embodiments, the driver assistance system may automatically generate one or more instructions or commands for actuating actuators of the attachment while simultaneously taking into account the mutually influencing optimization target variables. In one or some embodiments, the actuators of the attachment may be automatically actuated and/or automatically controlled hydraulically, pneumatically or electromechanically.

In one or some embodiments, the driver assistance system may automatically control at least one actuator of the at least one weight-supporting device and/or at least one actuator for automatically adjusting the working depth of tools of the attachment. For example, by automatically adjusting the height of the weight-supporting device to reduce the load thereupon, more load may be supported on the agricultural production machine.

Furthermore, in one or some embodiments, the driver assistance system may automatically perform a simultaneous height adjustment of the attachment interface and the at least one weight-supporting device. Simultaneous height adjustment of the power lifter and the set height of the at least one weight-supporting device may be used to adjust the working depth.

With the methodology disclosed, an increase in the tractive force potential may be achieved over the course of dynamic multi-objective control while improving or ensuring soil cultivation within a defined cultivation depth band. In addition, a reduction in tire wear and/or a reduction in tire damage may be achieved by preventing permanent overloading of tires and axles. The additional tractive force potential may also be used for increased soil tillage speed or output per area, wider soil tillage using attachments with a greater working width, or a reduction in area-specific fuel consumption.

In one or some embodiments, an agricultural work system is disclosed, comprising an agricultural production machine having at least two axles with at least one power lifter and an attachment which is connected to the agricultural production machine using the power lifter in order to perform an agricultural work process, and also a driver assistance system which optimizes the operation of the agricultural production machine and has a computing unit, a memory unit and an operating and display unit, wherein the computing unit is configured to process information generated by at least one sensor assembly, external information and information stored in the memory unit. The at least one sensor assembly may be configured to generate data in order for the driver assistance system to determine an axle load on at least one of the axles. The driver assistance system may be configured to cyclically automatically determine actual data records time-linked to the execution of the agricultural work process for the adjustment of the power lifter by the driver assistance system. An axle load ratio on the axles may be determined as an actual data record, and the driver assistance system may be configured to generate one or more instructions to control the power lifter using the actual data records and simultaneously taking into account a plurality of mutually influencing optimization target variables. Thus, the agricultural work system may be configured to performing any one, any combination, or all of the acts or actions discussed herein.

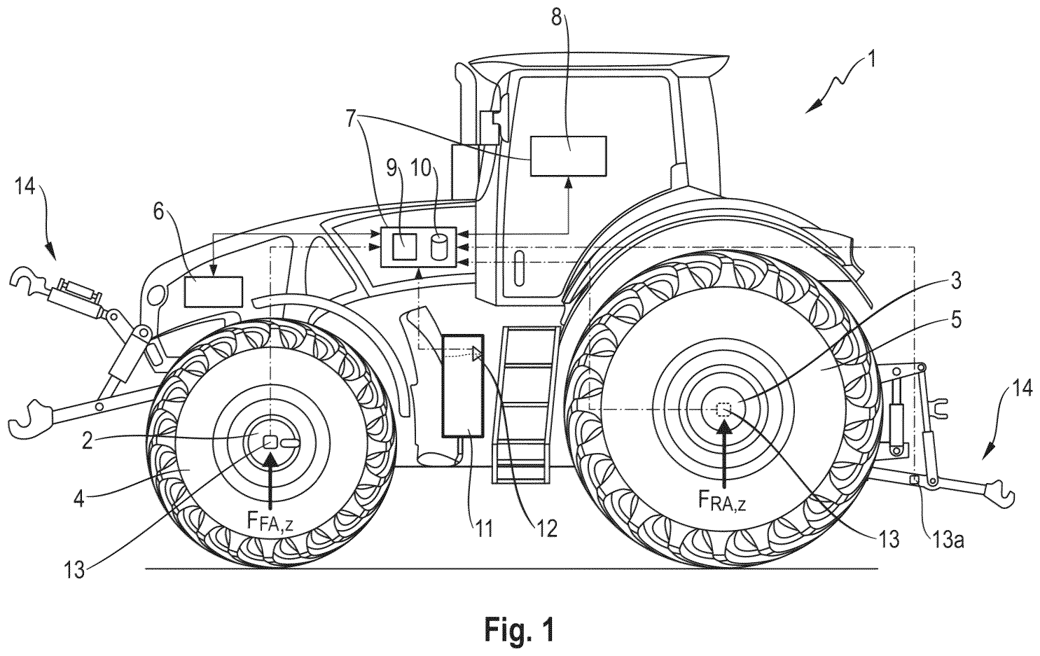

Referring to the figures, FIG. 1 shows a schematic side view of an agricultural production machine 1 of an agricultural work system. In one or some embodiments, the agricultural production machine 1 may comprise a tractor (an example of which is disclosed in US Patent Application Publication No. 2022/0000006 A1, incorporated by reference herein in its entirety) and may include soil engagement means 4, 5 (alternatively termed ground engagement means) arranged or positioned on axles 2, 3. In one or some embodiments, the soil engagement means 4, 5 comprises running wheels. Alternatively, the soil engagement means 4, 5 comprises tracks. Axle 2 may hereinafter be referred to as the front axle and axle 3 as the rear axle. The agricultural production machine 1 may be equipped with a drive unit 6, indicated schematically, which may comprise an internal combustion engine. The drive unit 6 may act or generate force, via a drive train, on the soil engagement means 4, 5 in the usual way. In one or some embodiments, the agricultural production machine 1 is an all-wheel drive agricultural production machine 1 so that all four soil engagement means 4, 5 are driven or drivable. FIG. 1 shows examples of vertical axle loads F_{FA,z} and F_{RA,z} acting on the front axle 2 and the rear axle 3, from which an axle load ratio 24 may be determined cyclically, and may take into account one or more other influencing variables.

In one or some embodiments, the agricultural production machine 1 has a driver assistance system 7, to which an operating and display unit 8 may be assigned. The operating and display unit 8 may provide an information interface (such as a touchscreen) to the operator of the agricultural production machine 1. The driver assistance system 7 further may include a memory unit 10 for saving data and/or software (e.g., software to perform the steps for the driver assistance system 7 discussed herein), and a computing unit 9 for processing the data stored in the memory unit 10.

Thus, in one or some embodiments, computing unit 9 may include at least one processor and optionally at least one memory (separate from memory unit 10) that stores information (e.g., data) and/or software to perform the functionality of the computing unit 9 described herein, with the processor configured to execute the software stored in the memory (e.g., the memory unit 10 may comprise a non-transitory computer-readable medium that stores instructions that when executed by processor performs any one, any combination, or all of the functions described herein). In this regard, the computing unit 9 may comprise any type of computing functionality, such as the at least one processor (which may comprise a microprocessor, controller, PLA, or the like) and the at least one memory. The memory may comprise any type of storage device (e.g., any type of memory). As shown in FIG. 1, computing unit 9 and memory unit 10 are depicted as separate elements. Alternatively, the computing unit 9 and memory unit 10 may be part of a single machine, which includes a microprocessor (or other type of controller) and a memory. Alternatively, computing unit 9 may rely on memory unit 10 for all of its memory needs.

The computing unit 9 and memory unit 10 are merely one example of a computational configuration. Other types of computational configurations are contemplated. For example, all or parts of the implementations may be circuitry that includes a type of controller, including an instruction processor, such as a Central Processing Unit (CPU), microcontroller, or a microprocessor; or as an Application Specific Integrated Circuit (ASIC), Programmable Logic Device (PLD), or Field Programmable Gate Array (FPGA); or as circuitry that includes discrete logic or other circuit components, including analog circuit components, digital circuit components or both; or any combination thereof. The circuitry may include discrete interconnected hardware components or may be combined on a single integrated circuit die, distributed among multiple integrated circuit dies, or implemented in a Multiple Chip Module (MCM) of multiple integrated circuit dies in a common package, as examples.

A container 11 designed as a fuel tank may be integrated into the body of the agricultural production machine 1. The container 11 (alternatively termed tank) may be equipped with a level sensor as the sensor assembly 12, which may be configured to automatically transmit (wired and/or wirelessly) measurement data (e.g., sensor data indicative of the level in container 11) via a signal line to the driver assistance system 7 for the driver assistance system 7 to evaluate.

A sensor assembly 13 may be assigned to at least one of the axles 2, 3 (such as to each of the axles 2, 3) of the agricultural production machine 1. In one or some embodiments, the sensor assembly 13 is assigned to the front axle 2. Using the measurement data (interchangeably termed sensor data) provided or generated by the sensor assembly 13 and evaluated by the driver assistance system 7, the driver assistance system 7 may determine the axle load arising or impinging on the front axle 2.

Furthermore, FIG. 1 illustrates schematically and exemplarily power lifters 14, which may be arranged or positioned at the front and/or rear (e.g., the power lifters 14 may comprise three-point power lifters with an upper link and lower link, which form device interfaces of the attachment 15). Thus, the agricultural production machine 1, which may be designed as a tractor, may generally have such a device interface, which may be designed as a power lifter 14, at the front and rear. In one or some embodiments, the power lifters 14 may form a hydraulically actuated device on the agricultural production machine 1 for coupling and lifting attachments 15. Also, in one or some embodiments, associated with the rear power lifter 14 is a sensor assembly 13a, which may generate data indicative of (or generated data used to determine) any one, any combination, or all of: pressure of actuators of the power lifter 14; position of actuators of the power lifter 14; or location of actuators of the power lifter 14. In one or some embodiments, actuators of the power lifter 14 may comprise lifting cylinders, upper links and lower links.

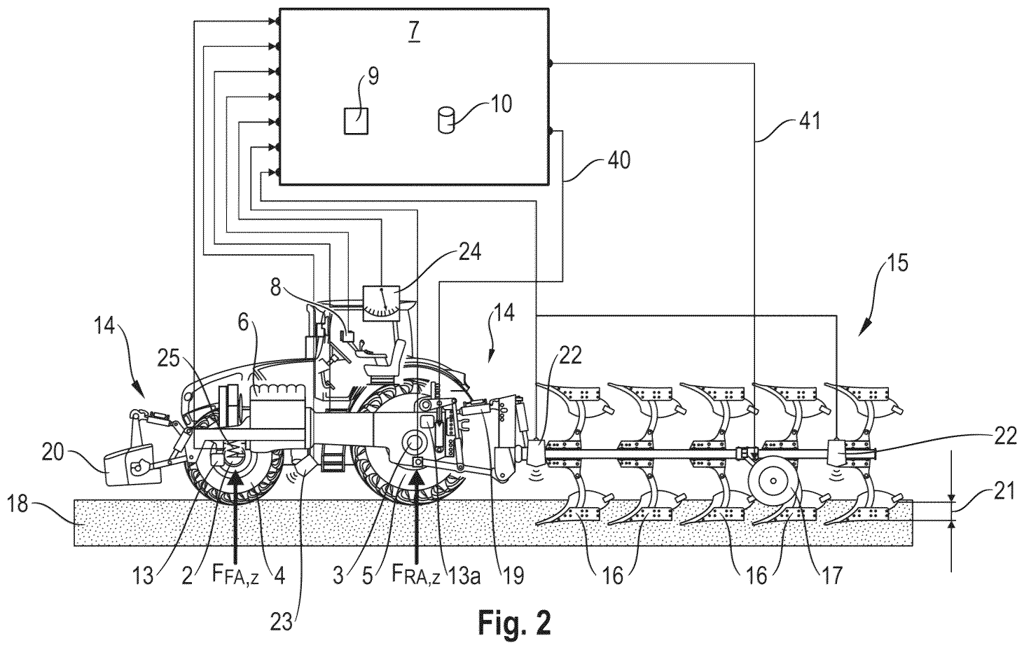

FIG. 2 schematically shows the agricultural work system comprising (or consisting of) agricultural production machine 1 and attachment 15 attached to power lifter 14, the attachment of which is for use during the execution of an agricultural work process. The attachment 15 attached to the device interface (e.g., power lifter 14) may be a soil cultivation device, such as a plow, a cultivator, a harrow or the like in the illustrated example.

Absolute axle loads and axle load ratio 24 may have a major influence on overall efficiency and operational safety when performing agricultural work processes. For example, an ideal axle load ratio may depend on the tires. The load transfer from the attachment 15 to the agricultural production machine 1 to reduce the tractive force requirement and rolling resistance may influence the axle load ratio 24 and the absolute axle loads. Furthermore, the axle load ratio 24 during the execution of a soil cultivation process may be influenced by the soil resistance and/or the fill level of a container of the attachment 15. Another aspect may be that a minimum front axle load should not be below a predetermined amount in order to enable sufficient steering behavior for the agricultural production machine 1. Furthermore, in one or some embodiments, the axle load ratio and/or the absolute axle loads should remain within designed limits to ensure the service life of the drive train.

In one or some embodiments, the attachment 15 mounted on the rear power lifter 14 has tools 16 for cultivating soil 18, such as plowshares by way of example. Furthermore, the attachment 15 may comprise at least one weight-supporting device 17, such as in the form of at least one support wheel arrangement. Furthermore, a traction booster 19 may be provided which may be configured to transfer a part of the weight of the attachment to the agricultural production machine 1. Thus, the traction booster 19 may transfer part of the weight of the attachment to the agricultural production machine 1 either by pulling on the upper link of the rear power lifter 14 or by a pressing drawbar cylinder.

In one or some embodiments, a weight 20 is arranged or positioned on the front power lifter 14 for ballasting.

For the cultivation of the soil, a working depth 21 may be set. The set working depth 21 may be monitored using one or more sensor assemblies 22, which may be arranged or positioned on the attachment 15. A further sensor assembly 23 may be arranged or positioned on the agricultural production machine 1, which may serve to detect the condition of the soil.

In one or some embodiments, the current axle load ratio 24 may be determined cyclically from the vertical axle loads F_{FA,z} and F_{RA,z} time-linked to the execution of the agricultural work process, and may be displayed to an operator of the agricultural production machine 1 using the operating and display unit 8. In one or some embodiments, the driver assistance system 7 may determine the vertical axle load F_{FA,z} and F_{RA,z} on at least one axle 2, 3 of the agricultural production machine 1, such as the front axle 2, for example, by means of or using the pressure in the hydropneumatic, pneumatic or mechanical suspension system 25. Alternatively, the driver assistance system 7 may determine the vertical axle load F_{FA,z} and F_{RA,z} based on the sensor data generated by a force-displacement measurement sensor system on the axle 2,3.

The driver assistance system 7 may determine the axle loads F_{FA,z}, F_{RA,z} arising or impinging on the axles 2, 3 of the agricultural production machine and the axle load ratio 24 based thereon cyclically by the computing unit 9 of the driver assistance system 7 time-linked to the execution of the agricultural work process, taking into account the agricultural production machine/attachment configuration and/or operating parameters of one or both of the agricultural production machine and the attachment. By way of example, one operating parameter comprises the ground condition, which may be determined by the sensor assembly 23.

For this purpose, the existing agricultural production machine and attachment configuration may be at least partially specified by the operator of the agricultural work system and/or at least partially determined automatically by the driver assistance system 7. Therefore, the determination of the dynamically changing axle loads F_{FA,z}, F_{RA,z} may be based on (such as determined based on) an initial ballasting of the agricultural work system, which may represent the initial values necessary for the subsequent determination during the agricultural work process. In so doing, the agricultural production machine and the attachment configuration may be at least partially selected by the operator of the agricultural work system from a database stored in the memory unit 10 of the driver assistance system 7. Alternatively or additionally, the driver assistance system 7 may determine at least part of the agricultural production machine configuration and/or the attachment configuration in an interactive dialog with the operator. Alternatively or additionally, the driver assistance system 7 may be configured to automatically determine the attachment 15. For this purpose, the driver assistance system may be configured to communicate with an attachment control system, for example, or to read out a data memory on the attachment 15.

Aspects of the agricultural production machine configuration may, among other things, comprise any one, any combination, or all of: the mass of the agricultural production machine 1; the position of the center of gravity of the empty agricultural production machine 1; the mass and position of additional weights 20 arranged or positioned on the agricultural production machine 1; and the type of device interface (e.g., type of power lifter 14) on the agricultural production machine 1 for connection to the attachment 15.

Aspects of the attachment configuration may, among other things, comprise any one, any combination, or all of: the mass of the attachment 15; the position of the center of gravity of the attachment 15; the point of application of the ground resistance forces/rolling resistances within the attachment 15; or the position of at least one weight-supporting device 17 optionally arranged or positioned on the attachment 15. For example, an estimation of the soil resistance forces on tools 16 for soil cultivation of the attachment 15 may be made using tractive power and vehicle speed. In turn, tractive power may be determined using drive engine power, transmission efficiency, drive train efficiency, and an efficiency of the soil engaging means 4, 5. Alternatively, the tractive power may be estimated using transmission output power, drivetrain efficiency, and efficiency of the soil engagement means 4, 5. Other operating parameter combinations for estimating the tractive power are contemplated.

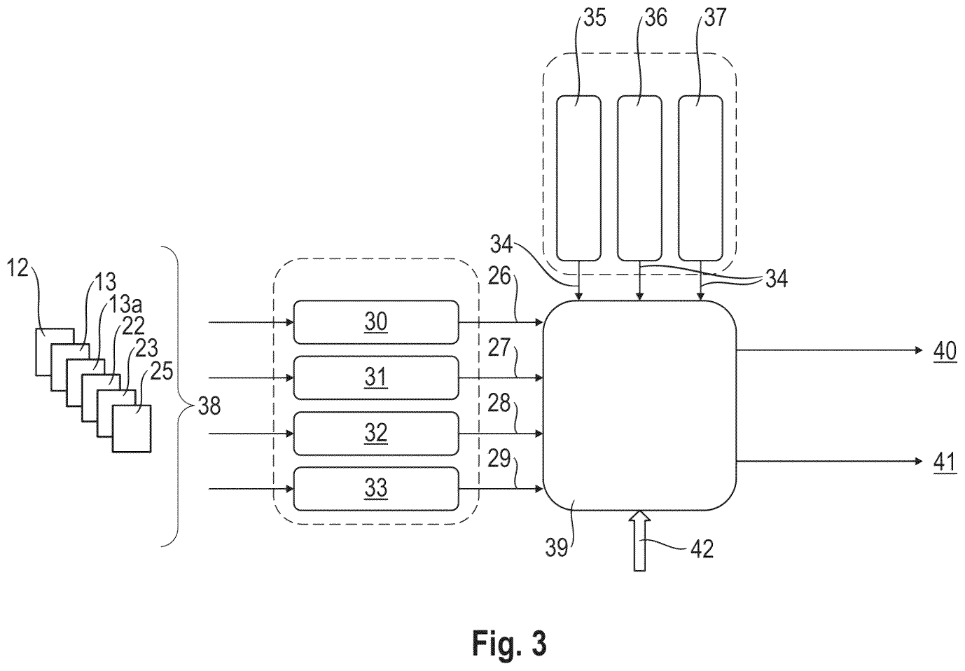

FIG. 3 shows a schematic overview of the structure of the driver assistance system 7. For the automatic adjustment of the power lifter 14 by the driver assistance system 7, the driver assistance system 7 may determine (e.g., cyclically determine) actual data records 26, 27, 28, 29 time-linked to the execution of the agricultural work process. For example, at predetermined times, the determinations may be performed. In one or some embodiments, an axle load ratio 24 currently at the axles 2, 3 is determined as an actual data record (“axle load ratio” 26). Using at least one additional actual data record 27, 28, 29, the driver assistance system 7 may generate instructions or commands indicative of (or for the purpose of transmitting to the power lifter) controlling the power lifter 14, such as the rear power lifter 14 while the driver assistance system 7 simultaneously taking into account a number of mutually influencing optimization target variables 42.

For this purpose, in one or some embodiments, an actual data record “slip” 27, an actual data record “working depth” 28, and/or an actual data record “internal tire pressure” 29 may be determined by the driver assistance system 7 as additional, such as dynamically changing, actual data records. These actual data records 27, 28, 29 may also be determined cyclically time-linked to the execution of the agricultural work process (e.g., at predetermined times). The actual data record “slip” 27 may be determined by a slip determination 31 (which may comprise software code to perform the determination), the actual data record “working depth” 28 may be determined by a working depth determination 32 (which may comprise software code to perform the determination) of tools 16 of the attachment 15 designed as a soil cultivation attachment, and the actual data record “internal tire pressure” 29 may be determined by an internal tire pressure determination 33 (which may comprise software code to perform the determination) of the soil engagement means 4, 5 (which may comprise tires). Determining the axle load ratio 24 as an actual data record 26, which may change dynamically, makes it possible to shift the axle loads between the axles 2, 3 into an optimum range. Using the slip determination 31 for determining the dynamically changing actual data record “slip” 27, the driving of the agricultural production machine 1 may be safe-guarded in the traction-capable range. The working depth determination 32 for determining the dynamically changing, actual data record “working depth” 28 may be used to reduce the rolling resistance on the attachment 15. Another aspect of determining the actual “working depth” data record 28 by determining the working depth may be to use it to increase the tractive force potential of the agricultural production machine 1, which may take into account the limited load-bearing capacity of the tires (which may comprise the soil engagement means 4, 5) as well as the axles 2, 3 of the agricultural production machine 1. The determination of inner tire pressure to determine the dynamically changing actual data record “inner tire pressure” 29 may be used for maintaining permissible axle loads for a set inner tire pressure as a target data record 34 or at least as a partial parameter of the target data record 34. In one or some embodiments, it may be taken into account that maximum permissible axle loads are not exceeded as an additional target data record 34 for the currently set internal tire pressure.

To determine deviations of the actual data records 26, 27, 28, 29 used to perform a multi-objective control 39, target data records 34 may be specified, which may be retrieved from an external and/or internal database 35, determined using at least one characteristic curve-based expert system 36 stored in the memory unit 10, and/or entered by an operator using a man-machine interface 37, such as by using a natural language interactive dialog. In one or some embodiments, the man-machine interface 37 may use the operating and display unit 8 of the agricultural production machine 1. Alternatively, the man-machine interface 37 may be a mobile data processing device, which may be configured to exchange data with the driver assistance system 7. The target data records 34 may be retrieved or determined for each optimization target variable 42 from the at least one expert system 36, the user inputs via the man-machine interface 37 and/or the databases 35.

The various sensor assemblies 12, 13, 22, 23, illustrated only by way of example in FIGS. 1 and 2, may provide the necessary measurement data 38, which may be made available to the algorithms to be executed by the computing unit 9 of the driver assistance system 7 for any one, any combination, or all of the following determinations: axle load determination 30; slip determination 31; working depth determination 32; or inner tire pressure determination 33.

In one or some embodiments, the dynamic multi-objective control 39 may determine one or more optimization variables such as any one, any combination, or all of: a target axle load ratio; a target load of weight-supporting devices 17 on the attachment 15; a target working depth; a target slip limit; and a maximum axle load dependent on the target inner tire pressure as a target data record 34. The various optimization target variables 42 may be based on any one, any combination, or all of a load and rolling friction reduction in the weight-supporting devices 17, a load increase or load transfer to the agricultural production machine 1 for a higher tractive force potential, an agronomically sensible working depth 21 of the attachment 15 designed as a soil cultivation attachment, and the prevention of overloading of the tires to avoid damage and increased wear as targets.

The dynamic multi-objective control 39, which may be the basis of the optimization process to be performed, may increase the overall efficiency of the agricultural work system in performing the agricultural work process.

In one or some embodiments, the driver assistance system 7 may generate and send a command to shift the axle load ratio 24 (alternatively termed axle load distribution) between the front axle 2 and the rear axle 3 of the agricultural production machine into an optimal range, which may result from the optimization target value 42 “target axle load ratio”, which may be based on the axle load measurement at the front axle 2, an estimation of the tool forces, the measurement of gradient and acceleration, and the calculation based on user inputs on the geometry and mass of the agricultural work system, which may be used to determine the current actual data record “axle load ratio” 26. This may allow for lifting movements in the power lifter to be taken into account, for example on hilltops or in valleys, that may result in a shift of weight and process forces to the agricultural production machine 1 or the weight-supporting device 17 on the attachment 15.

In this case, the load on weight-supporting devices 17 on the attachment 15, such as recompaction rollers, support wheels or the like, may be determined without additional sensors thereon. Thus, the multi-objective control 39 may reduce the load to decrease the rolling resistance on the attachment 15 as well as to increase the tractive force potential of the agricultural production machine 1, taking into account the limited load-bearing capacity of tires (which may comprise the soil engagement means 4, 5) and axles 2, 3 of the agricultural production machine 1.

The working depth 21 of the tools 16, such as the plow blade or cultivator tines, relative to the surface of the soil 18 to ensure the optimization target variable 42 of “target working depth” may be performed by measuring and calculating based on the detected position of the power lifter 14. Additionally or alternatively, a measurement and calculation may be performed using measurement data generated and provided by the working depth sensor (which is an example of the sensor assembly 22) in order for the driver assistance system to determine the current actual data record of “working depth” 28.

By determining the actual data record of “slip” 27, the driving of the agricultural production machine 1 in the traction-capable range, the target slip limit value may be secured as the optimization target value 42. A vehicle speed and tire circumferential speed may be determined for slip determination 31. The tire circumferential speed may be determined using data generated by a speed sensor arranged or positioned on the axle 2, 3 as well as data of the tires (e.g., data indicative of the size of the tires) stored in the agricultural production machine configuration on the at least one driven axle 2, 3 of the agricultural production machine. The measurement of the vehicle speed may additionally or alternatively be performed using radar, GPS, or comparable sensors.

To maintain the optimization target value 42 of “maximum axle load”, the driver assistance system may determine the current actual data record of “internal tire pressure” 29, which may be determined using tire pressure data generated by a sensor-based internal tire pressure determination 33 of the soil engagement means 4, 5 (which may comprise as tires).

As a result, the dynamic multi-objective control 39 may generate optimized instructions 40 for actuating the power lifter 14, such as instructions for the upper link and the lower link of the power lifter 14 designed as a three-point power lifter, which may take into account the various optimization target variables 42 and the associated specifications and influences.

In this way, overloading of the tires (which may comprise the soil engagement means 4, 5) and of the axles 2, 3 may be avoided. Further, an appropriate load on the weight-supporting devices 17 on the attachment 15 may be ensured. It may be made possible to maintain a defined working depth range. In particular, a location-dependent working depth 21 may be maintained. A tractive force sufficient for performing the agricultural work process is provided. Driven tires (which may comprise the soil engagement means 4, 5) may be prevented from slipping.

Moreover, the driver assistance system 7 may automatically generate instructions 41 for actuating actuators of the attachment 15 while simultaneously taking into account the mutually influencing optimization target variables 42.

At least one actuator of the at least one weight-supporting device 17 and/or at least one actuator for adjusting the working depth 21 of tools 16 of the attachment 15 may be automatically actuated. For this purpose, the driver assistance system 7 may automatically generate an instruction 41 to cause a height adjustment of the weight-supporting device 17 to reduce the load thereon by automatically actuating the actuators of the attachment 15 in order to support more load on the agricultural production machine 1.

Furthermore, the driver assistance system may automatically generate an instruction 41 for simultaneous height adjustment of the power lifter 14 and the at least one weight-supporting device 17 of the attachment 15. By simultaneously automatically adjusting the height of the rear power lifter 14 and the set height of the at least one weight-supporting device 17, an automatic adjustment of the working depth 21 may be achieved.

Further, it is intended that the foregoing detailed description be understood as an illustration of selected forms that the invention may take and not as a definition of the invention. It is only the following claims, including all equivalents, that are intended to define the scope of the claimed invention. Further, it should be noted that any aspect of any of the preferred embodiments described herein may be used alone or in combination with one another. Finally, persons skilled in the art will readily recognize that in preferred implementation, some, or all of the steps in the disclosed method are performed using a computer so that the methodology is computer implemented. In such cases, the resulting physical properties model may be downloaded or saved to computer storage.

### LIST OF REFERENCE NUMBERS

1 Production machine
2 Axle/front axle
3 Axle/rear axle
4 Tires
5 Tires
6 Drive unit
7 Driver assistance system
8 Operating and display unit
9 Computing unit
10 Memory unit
11 Container
12 Level sensor
13 Sensor assembly
13a Sensor assembly
14 Power lifter
15 Attachment
16 Tool
17 Weight-supporting device
18 Ground
19 Traction booster
20 Weight
21 Working depth
22 Sensor apparatus
23 Sensor apparatus
24 Axle-load distribution
25 Suspension system
26 “Axle load ratio” 26 actual data record
27 “Slip” actual data record
28 “Working depth” actual data record
29 “Inner tire pressure” actual data
30 Axle load determination
31 Slip determination
32 Working depth determination
33 Internal tire pressure determination
34 Target data record
35 Database
36 Expert system
37 Man/machine interface
38 Measurement data
39 Multi-objective control
40 Instructions
41 Instructions
42 Optimization target variables
FFA,z Vertical axle load of 2
FRA,z Vertical axle load of 3

1. A method for operating an agricultural work system for performing an agricultural work process, the agricultural work system comprising an agricultural production machine and an attachment, the agricultural production machine having at least two axles, at least one sensor assembly, at least one power lifter, and a driver assistance system comprising at least one processor, at least one memory, and at least one display, the attachment connected to the agricultural production machine using the power lifter a driver assistance system configured to control at least a part of operation of the agricultural production machine, the method comprising:
automatically accessing information generated by the at least one sensor assembly, external information, and information stored in the at least one memory;
automatically determining, based on the information generated by the at least one sensor assembly, at least one axle load on at least one of the axles;
automatically determining an axle load ratio currently on the at least two axles, wherein the axle load ratio is at least a part of actual data records coupled in time to execution of the agricultural work process;
automatically generating, using one or more of the actual data records, one or more instructions for actuating the at least one power lifter while simultaneously taking into account a plurality of mutually influencing optimization target variables; and
automatically controlling, using the one or more instructions, the at least one power lifter.

2. The method of claim 1, wherein one or more of a cyclically determined slip determination time-linked to execution of the agricultural work process, a determination of working depth of tools of the attachment designed as a soil cultivation device, or a determination of inner tire pressure of tires of the agricultural production machine is used to determine dynamically changing actual data records; and
wherein the dynamically changing actual data records are used for automatically generating the one or more instructions for actuating the at least one power lifter.

3. The method of claim 2, further comprising:
accessing target records, the target records being accessed based on at least one of: using a characteristic curve-based expert system; or based on a natural-language interactive dialog in order for an operator to provide input; and
determining deviations between the actual data records and the target records; and
wherein automatically generating the one or more instructions is based on the deviations between the actual data records and the target records in order to perform multi-objective control.

4. The method of claim 3, wherein accessing target records comprises accessing a target axle load ratio, a target load of at least one weight-supporting device on the attachment, a target working depth, a target slip limit value and a maximum axle load dependent on target internal tire pressure are determined as optimization target variables;
wherein determining deviations comprises determining deviations between: an axle load ratio and the target axle load ratio; a load of the at least one weight-supporting device on the attachment and the target load of the at least one weight-supporting device on the attachment; a working depth and the target working depth; a slip limit and the target slip limit value; and axle load and the maximum axle load; and
wherein automatically generating the one or more instructions is based on the deviations of: the axle load ratio and the target axle load ratio; the load of the at least one weight-supporting device on the attachment and the target load of the at least one weight-supporting device on the attachment; the working depth and the target working depth; the slip limit and the target slip limit value; and the axle load and the maximum axle load.

5. The method of claim 1, wherein the attachment comprises a soil cultivation device;
wherein a cyclically determined slip determination time-linked to execution of the agricultural work process, a determination of working depth of tools of the soil cultivation device, and a determination of inner tire pressure of tires of the agricultural production machine are used to determine dynamically changing actual data records; and
wherein the slip determination time-linked to execution of the agricultural work process, the working depth of tools of the soil cultivation device, and the inner tire pressure of tires of the agricultural production machine are used for automatically generating the one or more instructions for actuating the at least one power lifter.

6. The method of claim 1, wherein the axle loads arising on the at least two axles of the agricultural production machine and axle load ratio based thereon are determined cyclically time-linked to the execution of the agricultural work process; and
wherein the one or more instructions for actuating the at least one power lifter are automatically generated using the axle loads and the axle load ratio taking into account configuration of the agricultural production machine and the attachment and one or more operating parameters; and.

7. The method of claim 6, further comprising determining whether the attachment comprises a mounted attachment attached to the at least one power lifter or a trailed attachment; and
wherein determining the axle loads and the axle load ratio is dependent on whether the attachment comprises the mounted attachment attached to the at least one power lifter or the trailed attachment.

8. The method of claim 7, wherein, responsive to determining that the attachment is the trailed attachment or the mounted attachment for soil cultivation, determining the axle loads and the axle load ratio by:
in a first step, determining tool forces exerted on tools of the attachment via tractive power and current travel speed, wherein, responsive to determining that there is the mounted attachment, in the first step, a coupling torque from the attachment acting on the agricultural production machine and a vertical coupling force are also determined using attachment geometry and a moment equilibrium around at least one weight-supporting device of the attachment is determined; and
in a second step when there is the trailed attachment or the mounted attachment, a vertical axle load acting on a rear axle is determined.

9. The method of claim 1, further comprising determining working depth of tools of the attachment based on position of the at least one power lifter;
wherein the position of the at least one power lifter is determined by one or both of measurement or calculation; and
wherein the working depth of the tools of the attachment are used to automatically generate the one or more instructions for actuating the at least one power lifter.

10. The method of claim 9, wherein determining the working depth of the tools of the attachment is based on sensor data of at least one working depth sensor on the attachment.

11. The method of claim 1, further comprising determining slip determination based on vehicle speed of the agricultural production machine and a tire circumferential speed; and
wherein the slip determination is used to automatically generate the one or more instructions for actuating the at least one power lifter.

12. The method of claim 1, wherein a driver assistance system of the agricultural production machine automatically determines an optimum position for actuating the power lifter while simultaneously taking into account the plurality of mutually influencing optimization target variables.

13. The method of claim 12, wherein the driver assistance system further automatically generates one or more instructions for automatically actuating one or more actuators of the attachment while simultaneously taking into account the plurality of mutually influencing optimization target variables.

14. The method of claim 13, wherein the one or more actuators of the attachment comprise one or both of at least one actuator of the at least one weight-supporting device or at least one actuator for adjusting working depth of tools of the attachment; and
wherein the driver assistance system automatically generates the one or more instructions in order to control the one or both of the at least one actuator of the at least one weight-supporting device or the at least one actuator for adjusting the working depth of the tools of the attachment.

15. The method of claim 14, wherein the driver assistance system automatically generates the one or more instructions in order to perform a simultaneous height adjustment of the at least one power lifter and of the at least one weight-supporting device.

16. An agricultural work system comprising:
an agricultural production machine having at least two axles, at least one power lifter, at least one sensor assembly, and a driver assistance system;
an attachment configured to connect to the agricultural production machine using the at least one power lifter, wherein the agricultural work system is configured to perform an agricultural work process;
wherein the driver assistance system comprises at least one processor, at least one memory, and an operating and display unit, wherein the driver assistance system is configured to:
automatically access information generated by the at least one sensor assembly, external information, and information stored in the at least one memory;
automatically determine, based on the information generated by the at least one sensor assembly, at least one axle load on at least one of the at least two axles;
automatically determine an axle load ratio currently on the at least two axles, wherein the axle load ratio is at least a part of actual data records coupled in time to execution of the agricultural work process;
automatically generate, using one or more of the actual data records, one or more instructions for actuating the at least one power lifter while simultaneously taking into account a plurality of mutually influencing optimization target variables; and
automatically control, using the one or more instructions, the at least one power lifter.

17. The agricultural work system of claim 16, wherein the attachment comprises a soil cultivation device;
wherein the driver assistance system is configured to cyclically determine slip determination time-linked to execution of the agricultural work process, working depth of tools of the soil cultivation device, and inner tire pressure of tires of the agricultural production machine are used to determine dynamically changing actual data records; and
wherein the driver assistance system is configured to use the slip determination time-linked to execution of the agricultural work process, the working depth of tools of the soil cultivation device, and the inner tire pressure of tires of the agricultural production machine to automatically generate the one or more instructions for actuating the at least one power lifter.

18. The agricultural work system of claim 16, wherein a driver assistance system of the agricultural production machine is configured to:
automatically determine an optimum position for actuating the power lifter while simultaneously taking into account the plurality of mutually influencing optimization target variables; and
automatically generate one or more instructions for automatically actuating one or more actuators of the attachment while simultaneously taking into account the plurality of mutually influencing optimization target variables.

19. The agricultural work system of claim 18, wherein the one or more actuators of the attachment comprise one or both of at least one actuator of the at least one weight-supporting device or at least one actuator for adjusting working depth of tools of the attachment; and
wherein the driver assistance system is configured to automatically generate the one or more instructions in order to control the one or both of the at least one actuator of the at least one weight-supporting device or the at least one actuator for adjusting the working depth of the tools of the attachment.

20. The agricultural work system of claim 19, wherein the driver assistance system is configured to automatically generate the one or more instructions in order to perform a simultaneous height adjustment of the at least one power lifter and of the at least one weight-supporting device.
